(19) United States
(12) Patent Application Publication
(10) Pub. No.: US 2014/0030449 A1
(43) Pub. Date: Jan. 30, 2014

(54) ELECTROCHEMICAL DEVICE FABRICATION PROCESS WITH LOW TEMPERATURE ANNEAL

(71) Applicant: APPLIED MATERIALS, INC., Santa Clara, CA (US)

(72) Inventors: Daoying SONG, San Jose, CA (US); Chong JIANG, Cupertino, CA (US); Byung-Sung Leo KWAK, Portland, OR (US); Daniel Severin, Maintal (DE)

(21) Appl. No.: 13/951,702

(22) Filed: Jul. 26, 2013

Related U.S. Application Data
(60) Provisional application No. 61/676,232, filed on Jul. 26, 2012.

(51) Int. Cl. H01M 10/04

(52) U.S. Cl. CPC H01M 10/04
USPC 427/591; 427/596; 204/192.15

(57) ABSTRACT

A method of manufacturing an electrochemical device may comprise: depositing an electrode layer over a substrate using a physical vapor deposition (PVD) process in a deposition chamber, wherein the chamber pressure is greater than about 10 mTorr, and the substrate temperature is between about room temperature and about 450° C. or higher; and annealing the electrode layer for crystallizing the electrode layer, wherein the annealing temperature is less than or equal to about 450° C. Furthermore, the chamber pressure may be as high as 100 mTorr. Yet furthermore, the post-deposition annealing temperature may be less than or equal to 400° C. The electrochemical device may be a thin film battery with a LiCoO₂ electrode and the PVD process may be a sputter deposition process.

### CROSS-REFERENCE TO RELATED APPLICATIONS

This application claims the benefit of U.S. Provisional Application No. 61/676,232 filed Jul. 26, 2012, incorporated herein by reference in its entirety.

### FIELD OF THE INVENTION

The present invention relates to fabrication of electrochemical devices, and in particular, processes for electrochemical device electrode deposition with low temperature anneal.

### BACKGROUND OF THE INVENTION

All solid state Thin Film Batteries (TFB) are known to exhibit several advantages over conventional battery technology such as superior form factors, cycle life, power capability and safety. However, there is a need for cost effective and high-volume manufacturing (HVM) compatible fabrication technologies to enable broad market applicability of TFBs.

Most of the past and current state-of-the-art approaches, as they pertain to TFB and TFB fabrication technologies, have been conservative, wherein the efforts have been limited to scaling the basic technologies of the original Oak Ridge National Laboratory (ORNL) device development that started in the early 1990s. A summary of ORNL TFB development can be found in N. J. Dudney, Materials Science and Engineering B 116, (2005) 245-249.

FIGS. 1A to 1F illustrate a traditional process flow for fabricating a TFB on a substrate. In the figures, a top view is shown on the left and a corresponding cross-section A-A is shown on the right. There are also other variations, e.g., an “inverted” structure, wherein the anode side is grown first, which are not illustrated here. FIG. 2 shows a cross-sectional representation of a complete TFB, which may have been processed according to the process flow of FIGS. 1A to 1F.

As shown in FIGS. 1A and 1B, processing begins by forming the cathode current collector (CCC) 102 and anode current collector (ACC) 104 on a substrate 100. This can be done by (pulsed) DC sputtering of metal targets (˜300 nm) to form the layers (e.g. main group metals such as Cu, Ag, Pd, Pt and Au, metal alloys, metalloids or carbon black), followed by masking and patterning for each of the CCC and ACC structures. It should be noted that if a metallic substrate is used, then the first layer may be a “patterned dielectric” deposited after a blanket CCC 102 (the CCC may be needed to block Li in the cathode from reacting with the substrate). Furthermore, the CCC and ACC layers may be deposited separately. For example, the CCC may be deposited before the cathode and the ACC may be deposited after the electrolyte, as shown in FIG. 3. For current collector layers formed of metals such as Au and Pt that do not adhere well to, for example, oxide surfaces, adhesion layers of metals such as Ti and Cu can be used.

Next, in FIGS. 1C and 1D, the cathode 106 and electrolyte layers 108 are formed, respectively. RF sputtering has been the traditional method for depositing the cathode layer 106 (e.g. LiCoO₂) and electrolyte layer 108 (e.g. Li₃PO₄ in N₂). The cathode layer 106 can be a few to several or more microns thick, and the electrolyte layer 108 can be about 1 to 3 μm or more microns thick, sufficient to assure electrical isolation between cathode and anode.

Finally, in FIGS. 1E and 1F, the Li layer 110 and protective coating (PC) layer 112 are formed, respectively. The Li layer 110 can be formed using an evaporation or a sputtering process. The Li layer 110 can be a few to several or more microns thick (or other thickness depending on the thickness of the cathode layer) and the PC layer 112 can be in the range of 3 to 30 μm, and more depending on the materials constituting the layer and the required permeability specification. The PC layer 112 can be a multilayer comprising parylene (or other polymer-based material), metal or dielectric. Note that, between formation of the Li layer and the PC layer, the part must be kept in an inert or reasonably inert environment, such as argon gas or dry-room conditions.

There may be an additional “barrier” layer deposition step, prior to the CCC 102, if the CCC does not function as the barrier and if the substrate and patterning/architecture call for such a barrier layer. Also, the protective coating need not be a vacuum deposition step.

In typical processes, annealing of the cathode layer 106 will be required in order to improve the crystallinity of the layer if, for example, the TFB performance specification calls for “plateau of operating voltage”, high power capability and extended cycle life.

While some improvements have been made to the original ORNL approaches, there are many problems with the prior art fabrication processes for TFBs that prevent them from being compatible with cost effective and high-volume manufacturing (HVM), and thereby preclude broad market applicability of TFBs. For example, an issue with the state-of-the-art thin film cathode and cathode deposition process includes a need for a high temperature anneal to achieve a desirable crystalline phase, which adds to process complexity, low throughput and limitations on the choice of substrate materials.

Accordingly, a need remains in the art for fabrication processes and technologies for TFBs that are compatible with cost effective and high-volume manufacturing (HVM), and thereby enable broad market applicability of TFBs.

### SUMMARY OF THE INVENTION

The present invention relates to methods and apparatuses that overcome a key problem of current state-of-the-art fabrication technologies for thin film batteries (TFBs) that precludes broader market applications. The invention relates to the application of a low cost, high throughput PVD deposition process followed by anneal for cathode layers in thin film batteries. The deposition process is a high chamber pressure and high substrate temperature PVD deposition process—potentially up to 100 mTorr or more and up to 450° C. or higher for LiCoO₂ deposition—which permits annealing at significantly lower temperatures than low and medium range pressure and temperature deposition processes. The lower temperature anneal of less than 450° C.—low compared with the published standards ranging from 650° C. to 700° C.—provides a significant increase in throughput due to the shorter heat up and cool down times, as well as cost savings associated with lower power consumption of the furnace. (Note that the increase in throughput at the furnace more than compensates for the longer deposition time for the high pressure process and furthermore that deposition time can be reduced for the high pressure process by adjusting the argon to oxygen gas ratio and the power.) Furthermore, the lower temperature anneal leads to lower temperature induced thermal damage, such as stress induced fractures of the annealed layers and even to peeling of the layers, thus avoiding the thermal damage which can lead to yield losses and therefore, higher cost per produced cell. Yet furthermore, the lower temperature anneal may allow for elimination of an ex-situ anneal—a single integrated tool may be used for deposition and anneal. Furthermore, it is anticipated that it may be possible to eliminate the anneal altogether, according to some embodiments of the present invention. Herein, the PVD deposition process may include sputter deposition or thermal deposition, the latter including one or more of electron beam evaporation, laser ablation, inductive heating, etc.

According to some embodiments of the present invention, a method of manufacturing an electrochemical device may comprise: depositing a LiCoO₂ layer over a substrate using a sputter deposition process in a deposition chamber, wherein the chamber deposition pressure is greater than about 10 mTorr, and the substrate temperature is between about room temperature (22° C.) and about 450° C. or higher and the target comprises LiCoO₂; and annealing the LiCoO₂ layer for crystallizing the cathode layer, wherein the annealing temperature is about 450° C. or less and wherein the annealed LiCoO₂ layer is characterized by an A_{1g} mode peak at about 593 cm⁻¹ with a peak FWHM (full width at half maximum) of less than or equal to about 12 cm⁻¹ using Raman spectroscopy. Furthermore, the chamber deposition pressure may be greater than or equal to about 15 mTorr, about 30 mTorr, or even up to about 100 mTorr, the substrate temperature may be up to about 450° C. or higher, or between about 22° C. and about 300° C. and the anneal temperature may be about 450° C. or less, about 400° C. or less, or in some cases may be eliminated altogether. The argon to oxygen gas ratio in the deposition chamber and application of a bias voltage to the target and/or substrate may also be varied to improve throughput for the low temperature anneal process of the present invention. Further variations of process parameters may be used to provide the desired outcome of a high temperature phase cathode layer with a lower temperature anneal, as described herein. LiCoO₂ cathode layers without cracks after annealing, even with high temperature (650° C.) anneal, have been demonstrated for the high chamber pressure and high substrate temperature PVD processes according to some embodiments of the present invention.

Furthermore, the principles and teaching of the present invention may be applicable to the PVD deposition of other materials and to electrode layers in other devices such as electrochromic devices. For example, the present invention may provide low annealing temperatures for electrode materials in electrochemical devices, where examples of electrode materials include lithium cobalt oxides, nickel cobalt aluminum oxides, nickel cobalt manganese oxides, spinel-based oxides, olivine based phosphates, and lithium titanates, and where examples of electrochemical devices include thin film batteries and electrochromic devices. Examples of process conditions may include wherein the chamber deposition pressure is greater than about 10 mTorr, about 15 mTorr, about 30 mTorr, or even up to about 100 mTorr, the substrate temperature is between about room temperature (22° C.) and about 450° C. or higher, or between about 22° C. and about 300° C. and the anneal temperature is about 450° C. or less, about 400° C. or less, or in some cases may be eliminated altogether.

Furthermore, some embodiments of the present invention are tools for fabrication of the cathode layers with high deposition pressure and deposition temperature and low temperature anneal for crystallization.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIGS. 1A to 1F illustrate steps of a conventional process for forming TFBs;

FIG. 2 is a cross-sectional representation of a first prior art thin film battery;

FIG. 3 is a cross-sectional representation of a second prior art thin film battery;

FIG. 4 is an example of a Raman spectrum for an annealed LiCoO₂ film deposited under industry standard PVD conditions requiring a 650° C. anneal;

FIG. 5 is a plot of Raman A_{1g} phonon peak FWHM against deposition pressure for LiCoO₂ annealed at different temperatures, which illustrates the efficacy of deposition processes according to some embodiments of the present invention;

FIG. 6 shows Raman spectra for LiCoO₂ films deposited at different temperatures, but all annealed at 400° C., according to some embodiments of the present invention;

FIG. 7 is a plot of the Raman A_{1g} phonon peak FWHM from FIG. 6 against deposition temperature for LiCoO₂ annealed at 400° C., which illustrates the efficacy of deposition processes according to some embodiments of the present invention;

FIG. 8 is a schematic representation of a deposition system, according to some embodiments of the present invention;

FIG. 9 is a schematic illustration of a thin film deposition cluster tool, according to some embodiments of the present invention;

FIG. 10 is a representation of a thin film deposition system with multiple in-line tools, according to some embodiments of the present invention;

FIG. 11 is a representation of an in-line deposition tool, according to some embodiments of the present invention;

FIGS. 12 and 13 show optical micrographs of the surfaces of LiCoO₂ films deposited and annealed under different conditions, according to some embodiments of the present invention; and

FIGS. 14 and 15 show optical micrographs of the surfaces of LiCoO₂ films deposited and annealed under standard conditions.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Often in electrochemical devices, the active materials (in their final form) need to have good crystallinity, as opposed to having an amorphous or even microcrystalline structure. A typical cathode material in batteries (thin film or bulk) is LiCoO₂, which is deposited as an amorphous or microcrystalline layer under typical conditions of physical vapor deposition (PVD). As such, the deposited layers need to be annealed, typically using a furnace, to crystallize the film. The furnace temperature has to ramp up to hundreds of degrees to fully crystallize the film. This furnace anneal process takes several hours to complete as it goes through ramp up, soak, and cool down stages. While the throughput implications can be overcome with multiple furnaces, such an approach can lead to high cost of capital investment. In addition, the furnace anneal appears to deteriorate the interface between the cathode and cathode current collector and the properties (for example, the electrical conductivity) of the cathode current collector, leading to battery cells with higher impedance for poorer power (discharge/charge rate) capability. Furthermore, furnace anneal processes cause cracking of the LiCoO₂ cathode film due to a mismatch of the thermal expansion coefficient between the cathode and the substrate, where typical substrate materials are Si/SiN, glass, mica, metal foils, etc. Other radiation based rapid thermal annealing may be used. However, the breadth of wavelengths in typical broad spectrum lamps (a laser would be too expensive) means that the result of lamp annealing is very similar to that for the standard furnace anneal, including the undesirable side effects and throughput issues.

The typical PVD processes for cathode materials such as LiCoO₂ are in the middle or low deposition pressure region close to 5 mTorr and films produced by these conditions need high temperature—at least 650° C.—furnace (or lamp-based) annealing processes to fully crystallize them. In order to use low temperature furnace (or lamp and other electromagnetic wave-based) annealing processes, which avoid the unwanted side effects of a high temperature anneal, the present invention provides LiCoO₂ cathode deposition processes with higher chamber deposition pressure, and optionally one or more of higher substrate deposition temperature, higher O₂ to Ar gas ratio, applying bias to the pedestal and plasma treatments. Of these process conditions, for some of the embodiments of the present invention the higher deposition pressure and deposition temperature are the critical conditions to be satisfied. Furthermore, it is anticipated that it may be possible to eliminate the anneal altogether, according to some embodiments of the present invention. In general, the present invention overcomes one of the key problems of current state-of-the-art thin film battery (TFB) technologies that preclude them from being compatible with cost-effective and high-volume manufacturing. Herein, deposition pressure is used to refer to chamber pressure during deposition and deposition temperature is used to refer to substrate temperature during deposition. Furthermore, substrate temperature may be measured at the substrate pedestal when there is good thermal conductance between substrate and pedestal, or at the substrate using, for example, a pyrometer.

An example of a typical industry standard PVD deposition process for today which requires a high temperature anneal—650° C.—to provide a LiCoO₂ cathode layer with good crystallinity is provided as follows. The process is used to deposit a several micron thick layer of LiCoO₂ cathode material at a deposition rate of approximately 1 to 2 μm/hr-kW on a 200 mm diameter silicon substrate with a Ti/Au cathode current collector. An Applied Materials Endura™ 200 PVD chamber was used for a sputter deposition process, with the following process conditions.

| | |
|---|---|
| Pulsed DC Settings | f = 100 kHz; t_{off} = 1 μs |
| Target Power | 1 kW pulsed DC |
| Target | LiCoO₂ |
| Chamber Pressure | 5.5 mTorr |
| Ar/O₂ flow based ratio | 4 |
| Substrate Temperature | Room Temperature |

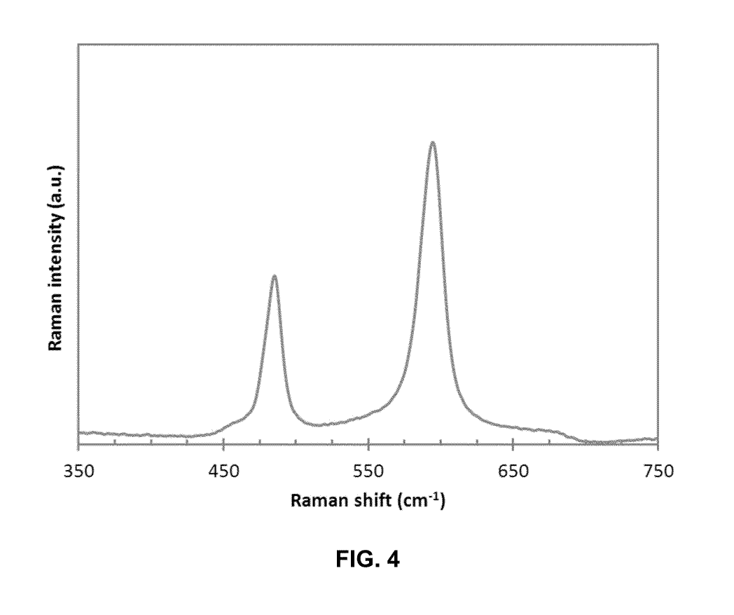

A Raman spectrum of the deposited film is shown in FIG. 4—this is an example of a film with the high temperature (HT) crystalline phase. Other PVD chambers, operated under high throughput conditions—typically low or mid-range pressure, ambient substrate deposition temperature, pulsed DC—can also be used to deposit the cathode layer. Note that the gas in the deposition chamber for a sputter deposition process, for example LiCoO₂ sputter deposition, will typically be comprised of argon, optionally plus a reactive gas. For non-sputter deposition PVD processes reactive gases and/or carrier gases may be used.

An example of a cathode deposition process according to some embodiments of the present invention which enables a lower temperature anneal—450° C. or maybe less—to provide a cathode layer with good crystallinity—see definition of good crystallinity provided below—is provided as follows. The process used to deposit an approximately several micron thick layer of LiCoO₂ cathode material was at a deposition rate of approximately 0.8 μm/hr-kW on a 200 mm diameter silicon substrate with a Ti/Au cathode current collector. An Applied Materials Endura™ 200 PVD chamber was used for the deposition process, with the following process conditions.

| | |
|---|---|
| Pulsed DC Settings | f = 100 kHz; t_{off} = 1 μs |
| Target Power | 1 kW pulsed DC |
| Target | LiCoO₂ |
| Chamber Pressure | 17 mTorr |
| Ar/O₂ flow based ratio | 1.5 |
| Substrate Temperature | 300° C. |

Note that the pulsed DC settings were chosen simply for the purpose of demonstrating the process according to some embodiments of the present invention; it is expected that different settings can be used. Furthermore, the process conditions listed above are an example and are not intended to be limiting, as it is expected that a wide range of process conditions may be utilized and achieve the desired result. Also, it is expected that good crystallinity may be achieved with even lower temperature anneals by extending the process regime described above. Other PVD chambers, operated under the conditions of the present invention can also be used to deposit the cathode layer.

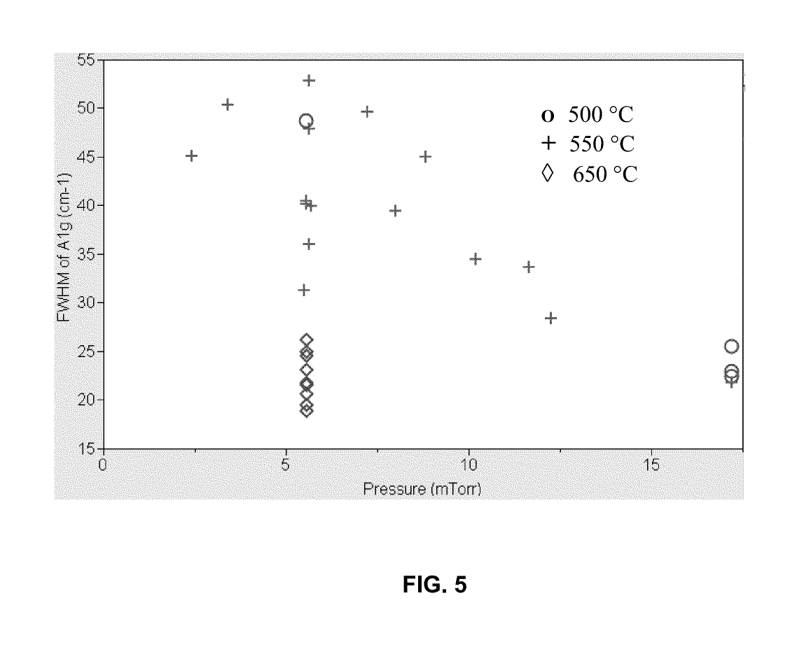

Typically, crystalline LiCoO₂ can have two phases, a low temperature phase (not desired for battery applications) and a high temperature phase (desired). As deposited LiCoO₂ is typically a low temperature phase material. In Raman spectra, the high temperature phase LiCoO₂ has an A_{1g} mode in the range of about 590 cm⁻¹ to about 596 cm⁻¹ (at about 593 cm⁻¹ or slightly higher in the examples provided herein) and the low temperature phase LiCoO₂ has an A_{1g} mode in the range of about 575 cm⁻¹ to about 584 cm⁻¹. Note that the Raman peak positions may shift due, for example, to film stress and calibration of the measurement tool; furthermore, the peak positions are given herein for pure phase materials, and if both high temperature and low temperature phases are present, the peaks will need to be deconvoluted to properly determine the high and low temperature phase peak positions. FIG. 5 shows a plot of the Raman A_{1g} phonon (high temperature phase) peak FWHM (full width at half maximum) against deposition pressure for LiCoO₂ films. The films are annealed at one of 500, 550 or 650° C. The FWHM of the A_{1g} phonon peak for each sample is determined using a three-peak Gaussian fit. Generally, the FWHM of the Raman peak is a good indication of the film crystallinity—the narrower the peak, the better the crystallinity; herein, good crystallinity is indicated by a FWHM of less than 25 cm⁻¹. (The data is collected using a JASCO NRS-3100 Raman Spectrometer with a 532 nm laser and using the following settings: filter open; 0.5×6 mm slit; 2×20 s integration time; 20× objective lens; and 1200 grid. The data presented in the figures provided herein is raw data, such that the FWHM of the A_{1g} peak includes a contribution from the measurement system itself. Therefore, a working definition of good crystallinity of an A_{1g} peak with FWHM of less than 12 cm⁻¹ is used, which is the peak broadening due to the material alone, having accounted for the system contribution.)

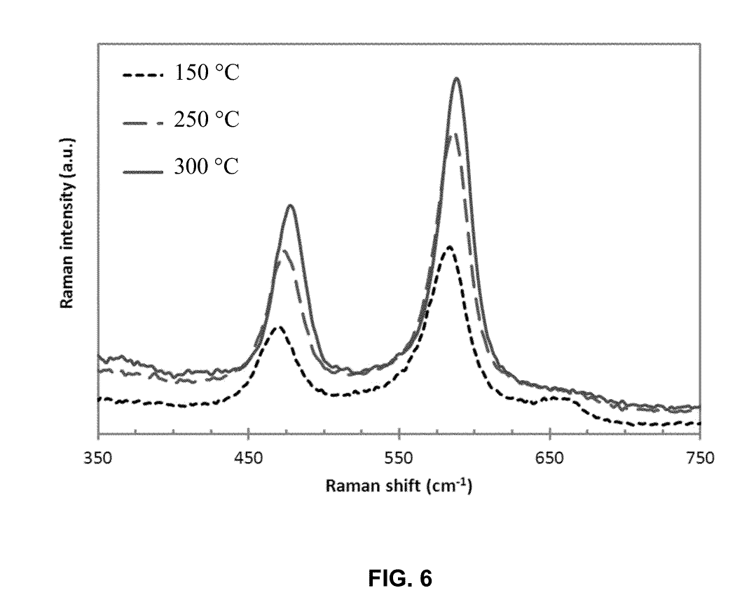

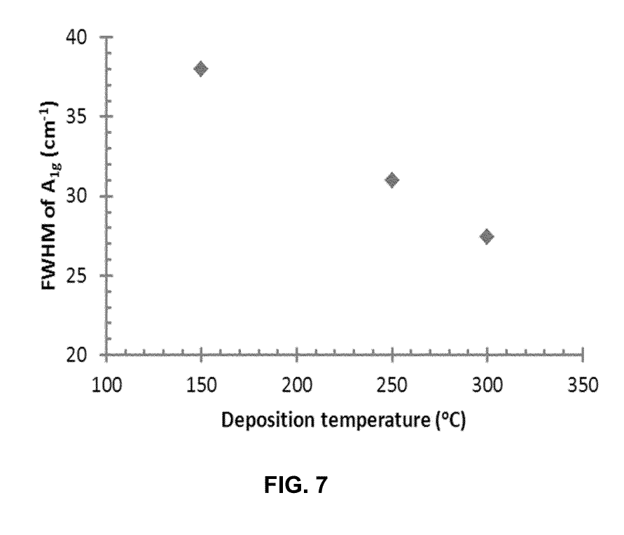

Importantly, FIGS. 6 and 7 show that the LiCoO₂ layers deposited at higher pressure and deposition temperature—approximately 17 mTorr and 300° C.—require annealing at only 450° C. to provide good crystallinity. (Note that FIGS. 6 and 7 provide measurements for LiCO₂ layers which have received an anneal at 400° C., which led to FWHM of slightly greater than the crystallinity definition of 25 cm⁻¹ (raw measurement), and it is estimated that an anneal at approximately 450° C. will be sufficient to provide LiCO₂ with “good crystallinity” as defined herein.) The lower temperature anneal—450° C. or less compared with the typical standard process, 650° C.—provides a significant increase in throughput due to the shorter heat up and cool down times, as well as cost savings associated with lower power consumption of the furnace. It is expected that by further increasing the deposition pressure and deposition temperature, potentially up to 30 mTorr and 450° C., the anneal temperature may be reduced below 400° C., and increasing the Ar to O₂ flow based ratio may provide a higher throughput for the deposition step (due to increasing sputtering rate with increase in amount of Ar)—implementation of one or both of these is expected to reduce the overall cost of the cathode deposition and anneal process. Furthermore, it is expected that further improvement in reducing anneal temperature may be seen when the deposition pressure is increased to 100 mTorr or more, although higher pressures may result in lower deposition rates. 100 mTorr may represent a reasonable upper limit from the consideration of deposition rate and thermal budget.

As indicated above, the Ar to O₂ flow based ratio plays a role in reducing the thermal budget, although this maybe not be as significant as the deposition pressure and temperature. Specifically, the greater the oxygen content, the greater the reduction in anneal requirement. Furthermore, an interaction has been observed between deposition temperature, chamber pressure and Ar/O₂ flow based ratio, where the signal is more prominent at higher chamber pressure and/or higher deposition temperatures. At higher chamber pressure and/or higher deposition temperature, greater oxygen content definitely enhances the thermal budget requirement during low temperature post-deposition annealing. However, higher oxygen content also leads to a greater propensity to form Co₃O₄, an impurity phase detrimental to capacity and cycle life. Also, it appears that an Ar/O₂ range of pure Ar to 90% Ar significantly increases the deposition rate, more than 2 times over the rate for an Ar/O₂ ratio of lower than 4. Based on these observations, a process with an Ar/O₂ ratio above 80% Ar is recommend in most circumstances for high throughput LiCoO₂ deposition processes with lower post-deposition annealing requirement and purer high temperature LiCoO₂ phase content.

Furthermore, in some embodiments other process conditions may be varied as well as the chamber pressure in order to enhance the LiCoO₂ cathode deposition process. For example, applying a DC bias to the substrate pedestal or forming a DC plasma over the target electrode may be effective in providing some further reduction in the annealing temperature required. Here the addition of energy (thermal, kinetic, plasma, etc.) to the depositing material/film induces better crystallization at the nucleation step and during the subsequent growth of the film.

Other TFB cathodes and anodes that may be suitable for the low cost deposition process as described above may include: layered cathode materials (e.g., nickel cobalt aluminum oxide (NCA) and nickel cobalt manganese oxides (NCM)), spinel-based oxides (e.g. lithium manganese oxide (LMO)), and olivine based phosphates such as lithium iron phosphate (LFP) for the cathode; and lithium titanate for the anode.

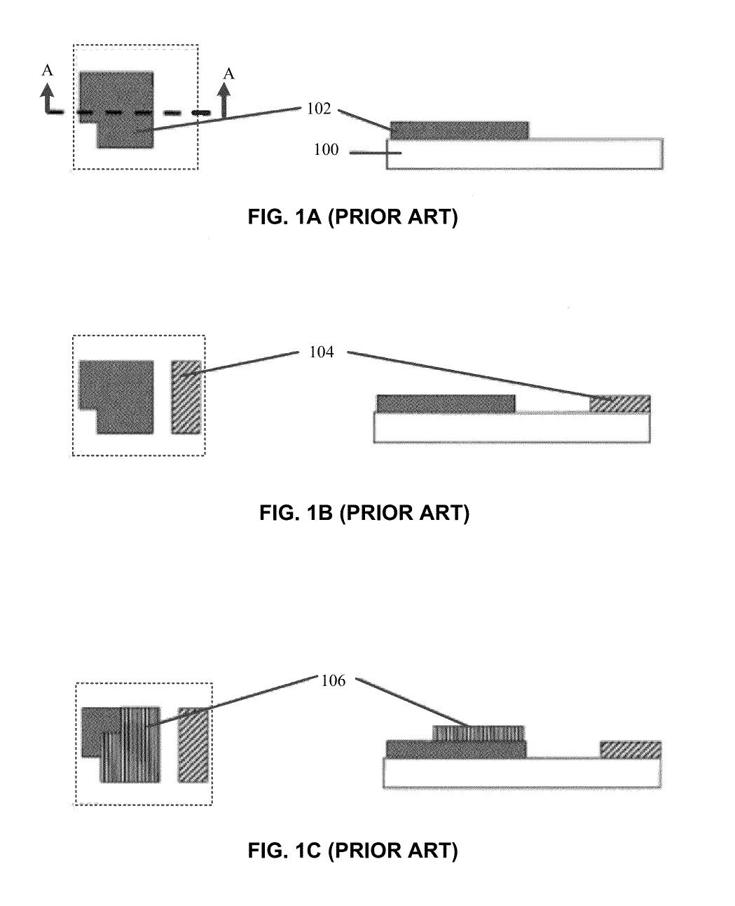

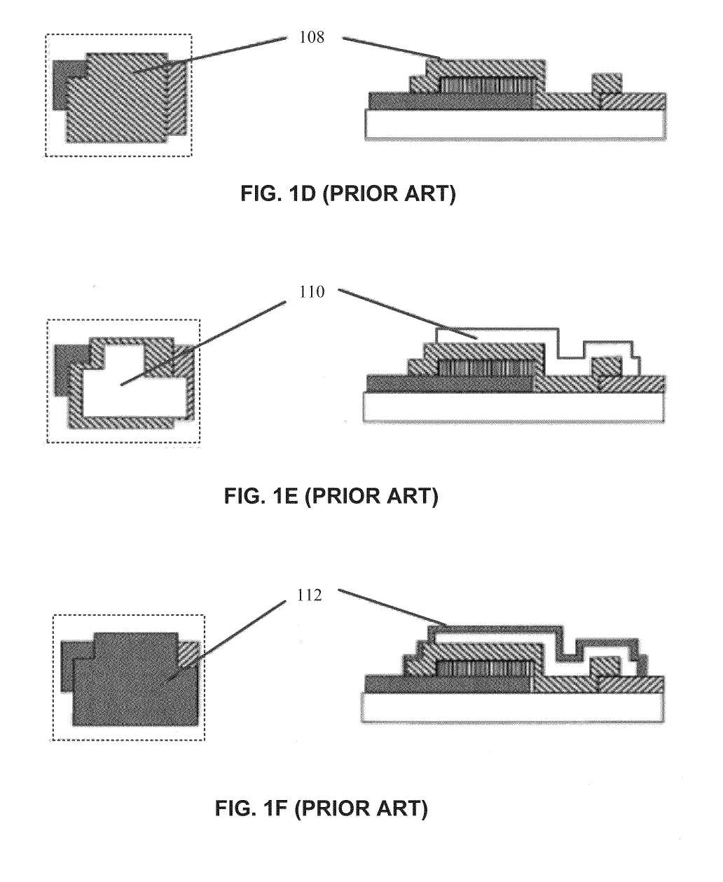

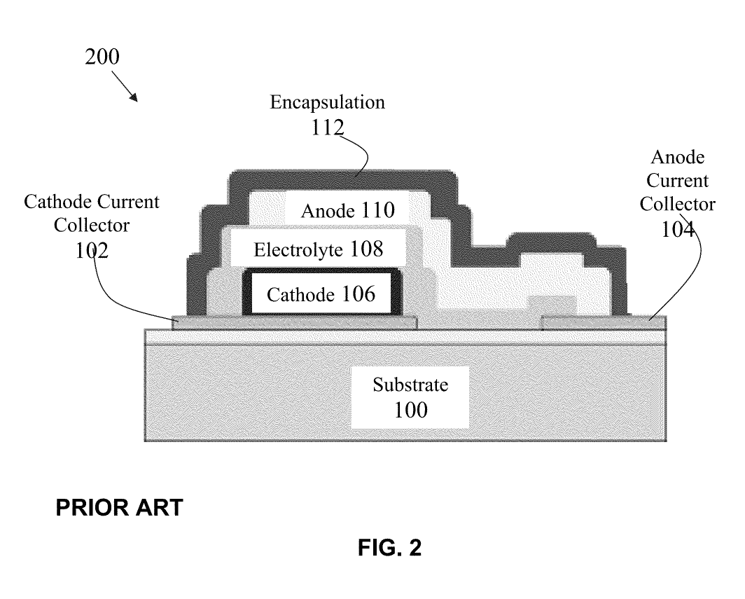

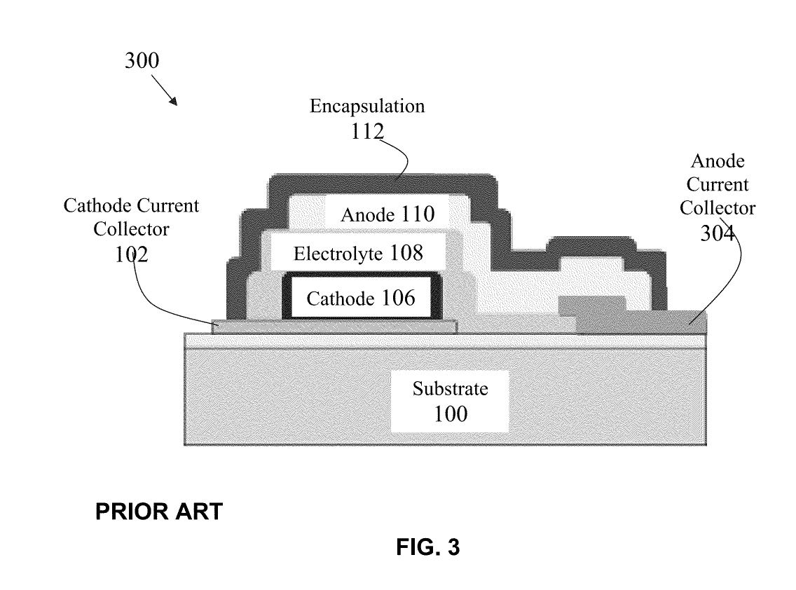

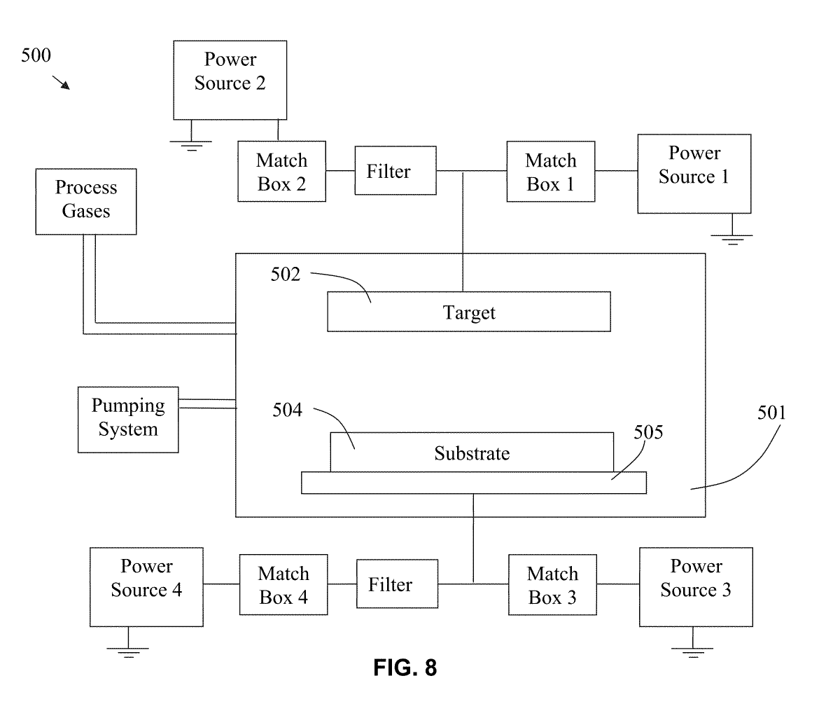

FIG. 8 shows a schematic representation of an example of a deposition tool 500 configured for deposition methods according to the present invention. The deposition tool 500 includes a vacuum chamber 501, a sputter target 502, a substrate 504 and a substrate pedestal 505. For LiCoO₂ deposition the target 502 is LiCoO₂ and a suitable substrate 504 may be Si/SiN, glass, mica, metal foils, etc., with current collector layers already deposited and patterned. See FIGS. 1A-1C, for example. The chamber 501 has a vacuum pump system and a process gas delivery system. Multiple power sources may be connected to the target. Each target power source may have a matching network for handling radio frequency (RF) power supplies, if needed. A filter is used to enable use of two power sources operating at different frequencies, where the filter acts to protect the target power supply operating at the lower frequency from damage due to higher frequencies. Similarly, multiple power sources may be connected to the substrate. Each power source connected to the substrate may have a matching network for handling radio frequency (RF) power supplies, if needed. A filter is used to enable use of two power sources operating at different frequencies, where the filter acts to protect the power supply connected to the substrate operating at the lower frequency from damage due to higher frequencies.

Depending on the type of deposition used, one or more of the power sources connected to the substrate can be a DC source, a pulsed DC (pDC) source, an AC source (with frequency below RF, typically below 1 MHz), an RF source, etc. Similarly, one or more of the target power sources can be a DC source, a pDC source, an AC source (with frequency below RF, typically below 1 MHz), an RF source, etc. Furthermore, combinations of more than one of the aforementioned substrate power sources may be connected to the substrate and/or combinations of more than one of the aforementioned target power sources may be connected to the target. The concepts and configurations of the combinatorial power supplies described in U.S. Patent Application Publication No. 2009/0288943 to Kwak et al., incorporated by reference in its entirety herein, may be used in the deposition of the thin films according to some embodiments of the present invention.

A first example of a combination of power sources is as follows: pDC power supply connected to the target, DC power supply connected to the substrate for providing a substrate bias. A second example is as follows: pDC power supply connected to the target, DC power supply also connected to the target for generating a DC plasma. Multiple further combinations may be used—for example, see U.S. Patent Application Publication No. 2009/0288943 to Kwak et al., incorporated by reference in its entirety herein.

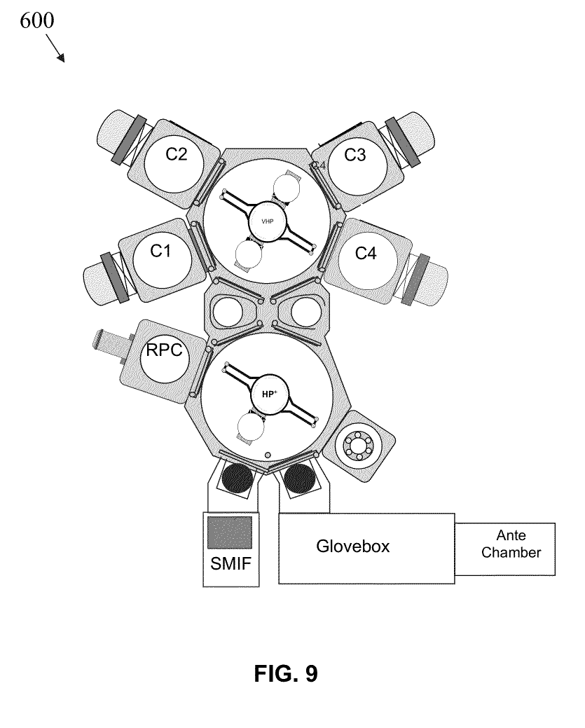

FIG. 9 is a schematic illustration of a processing system 600 for fabricating an electrochemical device, such as a TFB or EC device, according to some embodiments of the present invention. The processing system 600 includes a standard mechanical interface (SMIF) to a cluster tool equipped with a reactive plasma clean (RPC) chamber (or plasma clean (PC) chamber) and process chambers C1-C4, which may be utilized in the process steps described above. A glovebox may also be attached to the cluster tool if needed. The glovebox can store substrates in an inert environment (for example, under a noble gas such as He, Ne or Ar), which is useful after alkali metal/alkaline earth metal deposition. An ante chamber to the glovebox may also be used if needed—the ante chamber is a gas exchange chamber (inert gas to air and vice versa) which allows substrates to be transferred in and out of the glovebox without contaminating the inert environment in the glovebox. (Note that a glovebox can be replaced with a dry room ambient of sufficiently low dew point as such is used by lithium foil manufacturers.) The chambers C1-C4 can be configured for process steps for manufacturing thin film battery devices which may include a low cost cathode layer deposition and the low temperature annealing of the cathode layer according to some embodiments of the present invention, as described herein. Examples of potentially suitable cluster tool platforms include Applied Materials Endura™, and Centura™ for smaller substrates. It is to be understood that while a cluster arrangement has been shown for the processing system 600, a linear system may be utilized in which the processing chambers are arranged in a line without a transfer chamber so that the substrate continuously moves from one chamber to the next chamber.

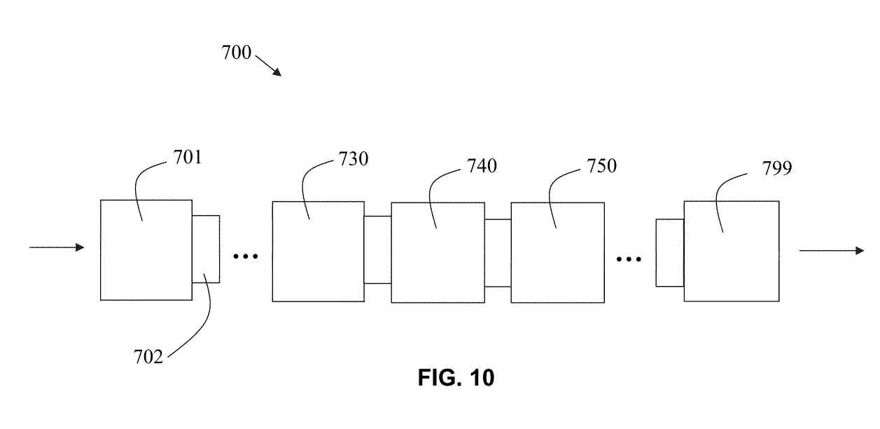

FIG. 10 shows a representation of an in-line fabrication system 700 with multiple in-line tools 701 through 799, including tools 730, 740, 750, according to some embodiments of the present invention. In-line tools may include tools for depositing all the layers of an electrochemical device—including both TFBs and electrochromic devices. Furthermore, the in-line tools may include pre- and post-conditioning chambers. For example, tool 701 may be a pump down chamber for establishing a vacuum prior to the substrate moving through a vacuum airlock 702 into a deposition tool. Some or all of the in-line tools may be vacuum tools separated by vacuum airlocks. Note that the order of process tools and the specific process tools in the process line will be determined by the particular device fabrication method being used. For example, one of the in-line tools may be dedicated to a low cost cathode layer deposition and another to low temperature anneal of the cathode layer according to some embodiments of the present invention, as described herein. Furthermore, some embodiments of the present invention may include an integrated tool for both deposition and low temperature anneal. Furthermore, substrates may be moved through the in-line fabrication system oriented either horizontally or vertically.

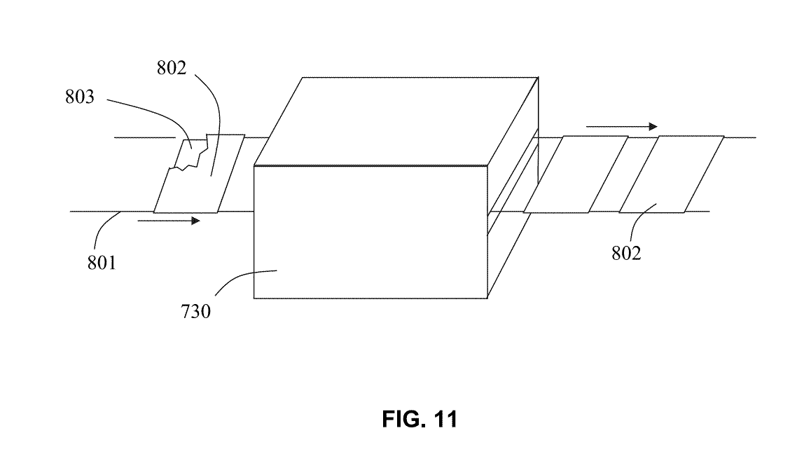

In order to illustrate the movement of a substrate through an in-line fabrication system such as shown in FIG. 10, in FIG. 11 a substrate conveyer 801 is shown with only one in-line tool 730 in place. A substrate holder 802 containing a substrate 803 (the substrate holder is shown partially cut-away so that the substrate can be seen) is mounted on the conveyer 801, or equivalent device, for moving the holder and substrate through the in-line tool 730, as indicated. A suitable in-line platform for processing tool 730 with vertical substrate configuration may be Applied Materials New Aristo™. A suitable in-line platform for processing tool 730 with horizontal substrate configuration may be Applied Materials Aton™.

In further embodiments, in-situ annealing of a cathode layer may be used, where the annealing is completed in the same chamber as the cathode layer deposition.

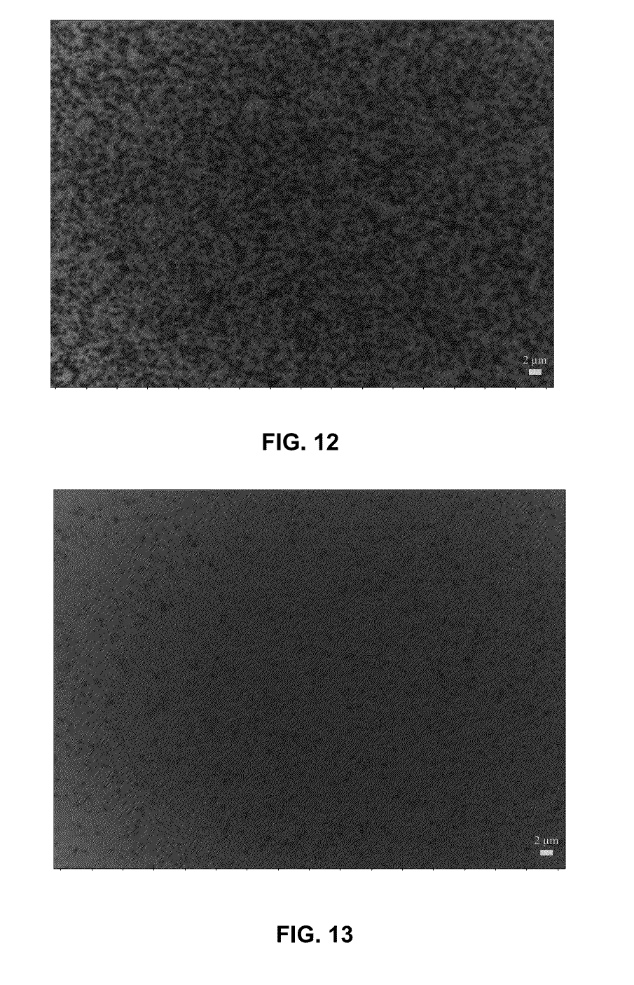

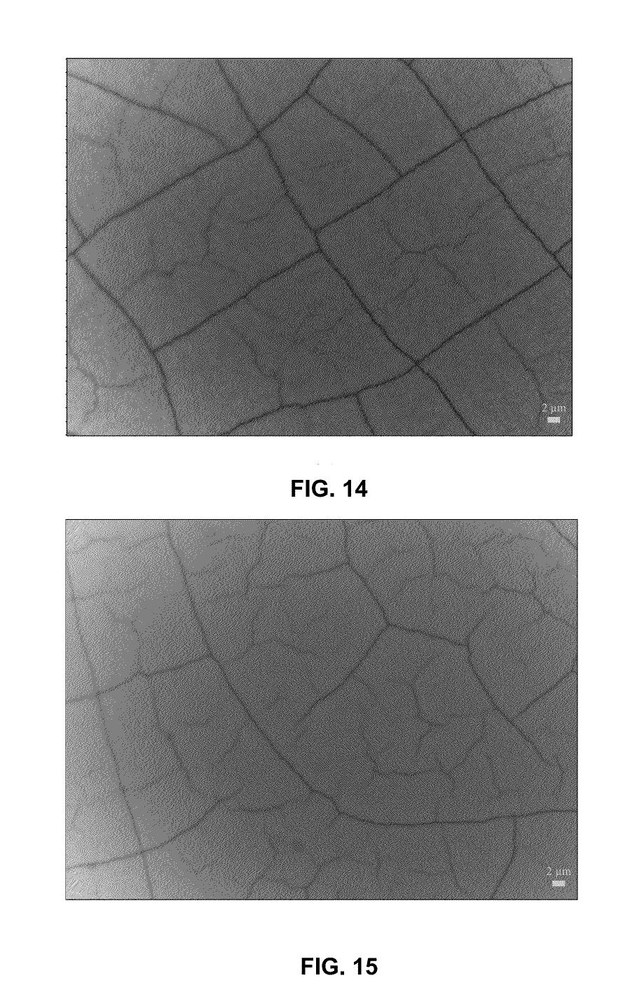

As described above, furnace anneal processes may cause cracking of the LiCoO₂ cathode film due to a mismatch of the thermal expansion coefficient between the cathode and the substrate. However, LiCoO₂ (LCO) cathode layers without cracks after annealing, even with high temperature (650° C.) anneal, have been demonstrated for the high pressure and high deposition temperature PVD processes according to some embodiments of the present invention. Screening of samples for cracks was made using optical microscopy with a resolution of approximately one micron and is illustrated in FIGS. 12 and 13. This is compared with the middle pressure regime and room temperature deposition conditions—which show significant cracking, as shown in FIGS. 14 and 15. More specifically, FIG. 12 shows an optical microscope image of a 2 μm thick LCO sample deposited at 17 mTorr and 250° C., and annealed at 650° C. FIG. 13 shows and optical microscope image of a 2 μm thick LCO sample deposited at 17 mTorr and 250° C., and annealed at 400° C. FIG. 14 shows an optical microscope image of a 2 μm thick LCO sample deposited at 5.5 mTorr and 25° C., and annealed at 650° C. FIG. 15 shows an optical microscope image of a 2 μm thick LCO sample deposited at 5.5 mTorr and 25° C., and annealed at 400° C. FIGS. 12-15 show that LCO deposited using the high pressure (17 mTorr) and high temperature (250° C.) process according to some embodiments of the present invention, does not develop cracks, even after high temperature, 650° C., annealing, while LCO deposited using a middle pressure (5.5 mTorr) and room temperature process develops a high density of cracks even after low temperature, 400° C., annealing. The benefit of having no or reduced cracking is better conformal coverage by the next layer, the electrolyte—leading to better yields and likely capability for thinner device layers for an overall higher production throughput and more cost-effective high volume manufacturing than is available from the standard processes.

Although the present invention has been described in detail for a sputter deposition PVD process, the principles and teaching of the present invention are expected to be beneficial for thermal PVD processes where a target material, such as LiCoO₂ is subject to one or more of electron beam evaporation, laser ablation, inductive heating, resistive heating, radiative heating from a hot body etc. It is expected that the ranges of deposition pressure and temperature determined for sputter deposition of LiCoO₂ will be applicable to thermal deposition processes, with the same result of reduced annealing temperature for crystallization of the LiCoO₂ layer to form a LiCoO₂ layer with the high temperature crystalline phase of good quality, as specified above. Furthermore, it is expected that these same ranges of deposition pressure and temperature, for the aforementioned PVD processes, will be beneficial for the other TFB anode and cathode materials disclosed herein, again with the result of reducing the annealing temperature for crystallization of the electrode material after deposition, when compared with the annealing temperature required for typical present day lower chamber pressure and lower substrate temperature deposition processes.

Although the present invention has been described for TFB cathode deposition which allows lower temperature annealing, the principles and teaching of the present invention are expected to be beneficial for deposition and annealing of electrodes in electrochromic (EC) devices. For example, the principles of the present invention are expected to improve the “forming” of nickel oxide based counter electrodes in EC devices, reducing the need for post-device-fabrication thermal cycling.

Furthermore, the higher pressure TFB cathode deposition of the present invention, which allows lower temperature furnace or lamp annealing, may be combined with a microwave anneal instead of a furnace or lamp anneal.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method of manufacturing an electrochemical device comprising:
depositing a LiCoO₂ layer over a substrate using a sputter deposition process in a deposition chamber, wherein the chamber pressure is greater than about 10 mTorr, and the substrate temperature is greater than about 22° C. and a sputter target comprises LiCoO₂; and
annealing said LiCoO₂ layer, wherein the annealing temperature is less than or equal to about 450° C. and wherein the annealed LiCoO₂ layer is characterized by an A_{1g} mode peak at about 593 cm⁻¹ with a peak FWHM of less than or equal to about 12 cm⁻¹ using Raman spectroscopy.

2. The method as in claim 1, wherein said chamber pressure is greater than or equal to about 15 mTorr.

3. The method as in claim 1, wherein said chamber pressure is greater than or equal to about 30 mTorr.

4. The method as in claim 1, wherein said chamber pressure is less than or equal to about 100 mTorr.

5. The method as in claim 1, wherein said substrate temperature is greater than about 450° C.

6. The method as in claim 1, wherein said substrate temperature is between about 22° C. and about 450° C.

7. The method as in claim 1, wherein said substrate temperature is between about 22° C. and about 300° C.

8. The method as in claim 1, wherein said annealing temperature is less than or equal to about 400° C.

9. The method as in claim 1, wherein said depositing is in an argon and oxygen gas environment, with an Ar:O₂ flow based ratio of greater than about 80%.

10. The method as in claim 1, wherein said electrochemical device is a thin film battery.

11. The method as in claim 1, wherein said LiCoO₂ layer is deposited on a current collector layer.

12. The method as in claim 1, wherein said annealing is in said deposition chamber.

13. A method of manufacturing an electrochemical device comprising:
depositing an electrode layer over a substrate using a physical vapor deposition (PVD) process in a deposition chamber, wherein the chamber pressure is greater than about 10 mTorr, and the substrate temperature is greater than about 22° C.; and
annealing said electrode layer for crystallizing said electrode layer, wherein the annealing temperature is less than or equal to about 450° C.

14. The method as in claim 13, wherein said substrate temperature is greater than about 450° C.

15. The method as in claim 13, wherein said substrate temperature is between about 22° C. and about 450° C.

16. The method as in claim 13, wherein said annealing temperature is less than or equal to about 400° C.

17. The method as in claim 13, wherein said electrochemical device is a thin film battery.

18. The method as in claim 13, wherein said electrode layer comprises a material selected from the group consisting of lithium cobalt oxides, nickel cobalt aluminum oxides, nickel cobalt manganese oxides, spinel-based oxides, olivine based phosphates, and lithium titanates.

19. The method as in claim 13, wherein said PVD process is a sputter deposition process.

20. The method as in claim 13, wherein said PVD process is a thermal deposition process.
